(19) United States
(12) Patent Application Publication
(10) Pub. No.: US 2011/0243005 A1
(43) Pub. Date: Oct. 6, 2011

(54) Mobility cell measurement method and apparatus for mobile communications system

(75) Inventor: Chengjun Sun, Beijing (CN)

(73) Assignees: Samsung Electronics Co., Ltd.; Beijing Samsung Telecom R & D Center; .

(21) Appl. No.: 13/065,613

(22) Filed: Mar. 25, 2011

(30) Foreign Application Priority Data
Apr. 2, 2010 (CN) 201010144619.1

(51) Int. Cl. H04W 24/00

(52) U.S. Cl. 370/252

(57) ABSTRACT

This invention provides a mobility cell measurement method and apparatus for a mobile communications system like as LTE-A. The method includes: performing inter-carrier synchronous transmission of a synchronous signal on at least two Component Carriers (CCs); sending information regarding one or more CCs among the at least two CCs that is capable of performing Carrier Aggregation (CA) with a carrier of a serving cell to a user equipment through higher-level signaling; and sending joint mobility measurement information to the user equipment of the serving cell, wherein the user equipment determines a CC for performing joint mobility measurement according to the information regarding the one or more CCs and the joint mobility measurement information and performs the joint mobility measurement on the determined CC. This increases the speed of the mobility measurement and reduces the power consumption of the user equipment.

### CROSS-REFERENCE TO RELATED APPLICATION(S) AND CLAIM OF PRIORITY

The present application claims the benefit under 35 U.S.C. §119(a) to a Chinese patent application filed in the Chinese Intellectual Property Office on Apr. 2, 2010 and assigned Serial No. 201010144619.1, the entire disclosure of which is hereby incorporated by reference.

### TECHNICAL FIELD OF THE INVENTION

The present invention relates to the field of mobile communication technologies and, more particularly, to a mobility cell measurement method and apparatus for a mobile communications system.

### BACKGROUND OF THE INVENTION

In an existing Long Term Evolution (LTE) system, various system bandwidths, 1.4 MHz, 3 MHz, 5 MHz, 10 MHz, 15 MHz and 20 MHz, can be supported. Regardless of the system bandwidth, a Primary Synchronization Signal (PSS) and a Secondary Synchronization Signal (SSS) used for mobility measurement are both transmitted on a bandwidth of 6 Resource Blocks (RBs) at a center of the entire system bandwidth, which is approximately 1M. Accordingly, when a user equipment (UE) performs the mobility measurement of radio resource management, cell identification is performed on only the PSS and SSS on the 6 RBs at such center of the system bandwidth at each time the measurement is performed, regardless of the system bandwidth.

Specifically, according to minimum performance requirements in performance requirement specifications of the radio resource management of 3rd Generation Partnership Project (3GPP), the user equipment will perform the measurement of a Reference Signal Received Power (RSRP) on only a Cell specific Reference Signal (CRS) in the 6 RBs at the center, so as to perform a cell reselection of an idle mode or a switching of a connected mode.

During the mobility measurement of the user equipment, a base station (BS) will provide information regarding an adjacent cell to the user equipment through a broadcast message or Radio Resource Control (RRC) signaling. In the available LTE system, the base station will provide carrier frequency information on how the adjacent cell differs from the current cell to the user equipment, so that the user equipment measures the different-frequency adjacent cell in the mobility measurement. However, when the user equipment measures the different-frequency adjacent cell, the user equipment will measure those different-frequency carriers one by one. Thus, mobility measurement time of the different-frequency cell is a sum of the measurement time of every different-frequency carrier. As a quantity of the different-frequency carrier increases, the time delay of the mobility measurement is larger, and power consumption of the user equipment is larger.

In the LTE-Advance (LTE-A) system, Carrier Aggregation (CA) techniques, in which a larger operation bandwidth is obtained by aggregating multiple Component Carriers (CCs), are proposed in order to support a higher transmission rate. For example, a support for the bandwidth of 100 MHz can be achieved by aggregating 5 CCs of 20 MHz.

The available LTE-A system mainly supports 3 CA deployment policies as follows.

Deployment scenario 1: base station antennae corresponding to the CCs for the CA are in the same location, and have coverage ranges highly close to each other.

Deployment scenario 2: base station antennae corresponding to the CCs for the CA are in the same location and are in the same direction, but the coverage range of the cell that one of the CCs is located is smaller than the coverage of the cell that another CC is located.

Deployment scenario 3: base station antennae corresponding to the CCs for the CA are in the same location and are in distinct direction.

However at present, the 3GPP has not determined a mobility measurement method with respect to the LTE-A system. For the LTE-A system, the user equipment needs to measure more different-frequency carriers due to the proposal of the CA techniques. If the mobility measurement method in the LTE system is still used, the user equipment performs the measurement on the 6 RBs at the center of the different-frequency carrier one by one, which apparently leads to longer time and larger power consumption resulting from the mobility measurement.

### SUMMARY OF THE INVENTION

To address the above-discussed deficiencies of the prior art, it is a primary object to provide a mobility measurement method for a mobile communications system such as an LTE-A system, so as to increase the speed of the mobility measurement and reduce the power consumption of the user equipment.

A mobility cell measurement method for a mobile communications system, which includes:

performing inter-carrier synchronous transmission of a synchronous signal on at least two Component Carriers CCs;

sending information regarding one or more CCs among the at least two CCs that can be carrier aggregated with a carrier of a serving cell to a user equipment through higher-level signaling; and

sending joint mobility measurement information to the user equipment of the serving cell, so that the user equipment determines a CC for performing joint mobility measurement according to the information regarding one or more the CC and the joint mobility measurement information and performs the joint mobility measurement on the determined CC.

A mobility cell measurement method for a mobile communications system, which includes:

performing inter-carrier synchronous transmission of a synchronous signal on at least two Component Carriers CCs;

sending joint mobility measurement information to a user equipment of the serving cell, so that the user equipment determines a CC for performing joint mobility measurement according to the joint mobility measurement information and performs the joint mobility measurement on the determined CC.

As can be seen from the above technical solutions, in the method provided by the present invention, by performing the synchronous transmission of the synchronous signal on at least two CCs that have corresponding antennae which have the same location and sending the information regarding the CC that is capable of performing the CA with the carrier of the serving cell and the joint mobility measurement information to the user equipment, the user equipment can determine the CC for performing the joint mobility measurement according to this information and can perform the joint mobility measurement on the determined CC without measuring the different-frequency carriers one by one, which improves the performance of the measurement, increases the speed of the mobility measurement and reduces the power consumption of the user equipment.

Before undertaking the DETAILED DESCRIPTION OF THE INVENTION below, it may be advantageous to set forth definitions of certain words and phrases used throughout this patent document: the terms “include” and “comprise,” as well as derivatives thereof, mean inclusion without limitation; the term “or,” is inclusive, meaning and/or; the phrases “associated with” and “associated therewith,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, or the like; and the term “controller” means any device, system or part thereof that controls at least one operation, such a device may be implemented in hardware, firmware or software, or some combination of at least two of the same. It should be noted that the functionality associated with any particular controller may be centralized or distributed, whether locally or remotely. Definitions for certain words and phrases are provided throughout this patent document, those of ordinary skill in the art should understand that in many, if not most instances, such definitions apply to prior, as well as future uses of such defined words and phrases.

### BRIEF DESCRIPTION OF THE DRAWINGS

For a more complete understanding of the present disclosure and its advantages, reference is now made to the following description taken in conjunction with the accompanying drawings, in which like reference numerals represent like parts:

FIG. 1 is a flow chart illustrating a main method provided by the present invention;

FIGS. 2A and 2B are schematic diagrams illustrating synchronous transmission of a synchronous signal in a Frequency Division Duplex (FDD) system and a Time Division Duplex (TDD) system, respectively;

FIG. 3 is a schematic diagram illustrating a combining joint cell identification method;

FIGS. 4A and 4B are schematic diagrams illustrating a selective joint cell identification method corresponding to the same Physical Cell ID (PCI) and distinct PCIs, respectively; and

FIG. 5 is a flow chart illustrating another method provided by the present invention.

### DETAILED DESCRIPTION OF THE INVENTION

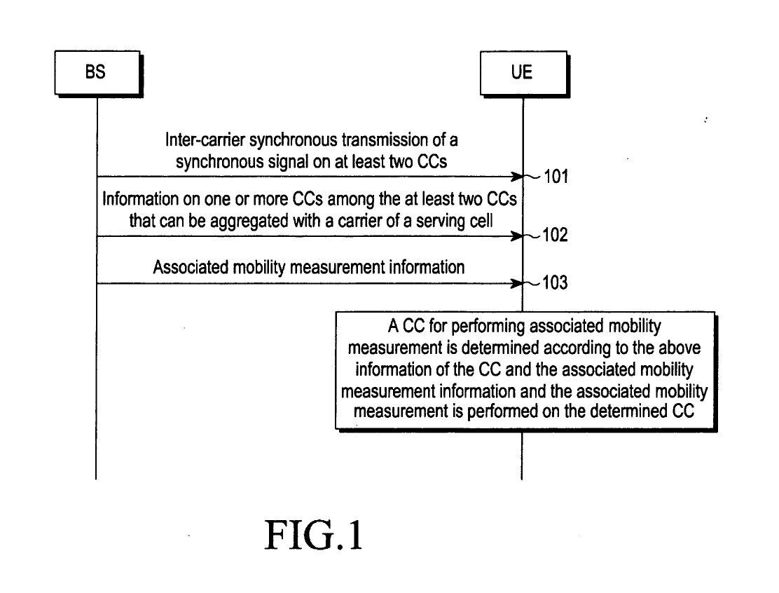

FIGS. 1 through 5, discussed below, and the various embodiments used to describe the principles of the present disclosure in this patent document are by way of illustration only and should not be construed in any way to limit the scope of the disclosure. Those skilled in the art will understand that the principles of the present disclosure may be implemented in any suitably arranged mobile communications system. To make the objects, technical solutions and advantages of the present invention more apparent, the present invention is described in detail herein below with reference to the accompanying drawings and specific embodiments.

A method provided by the present invention can be as shown in FIG. 1, which mainly includes steps as follows.

Flow 101: Inter-carrier synchronous transmission of a synchronous signal is performed on at least two CCs.

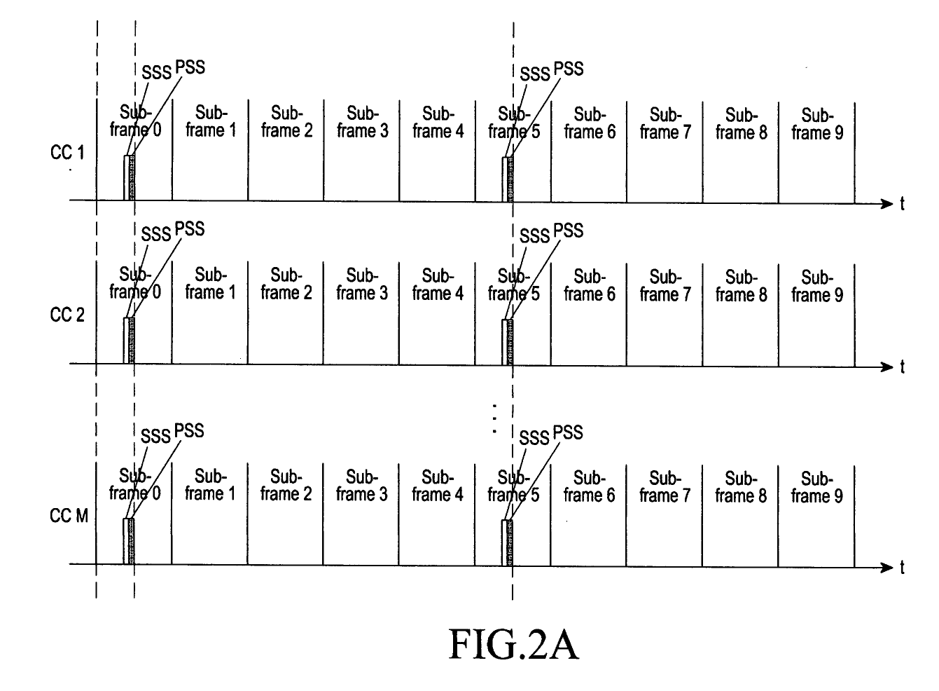

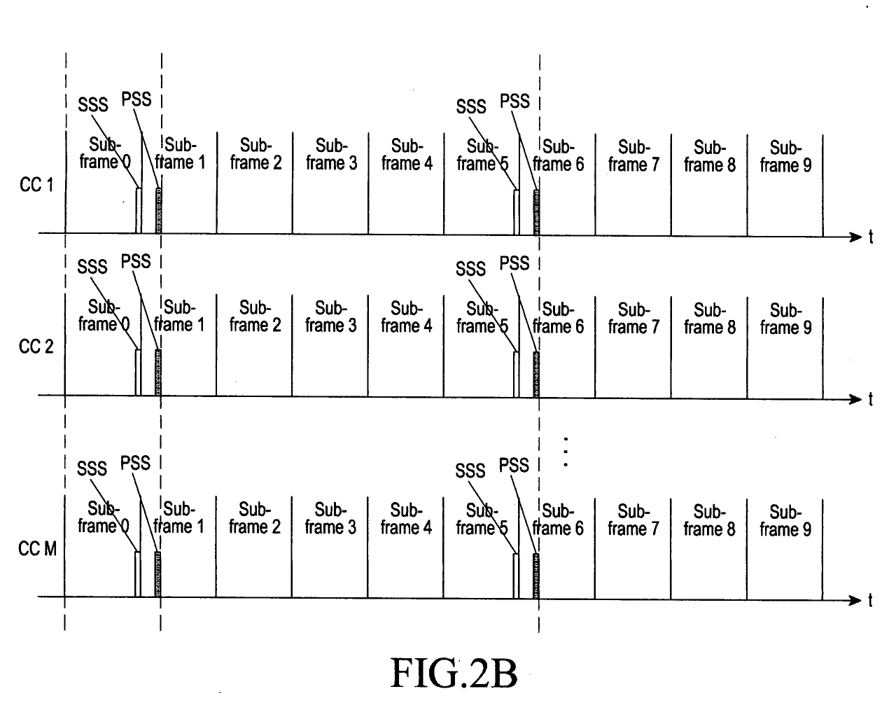

At flow 101, the base station can perform the inter-carrier synchronous transmission of the synchronous signal on the CCs that have corresponding antennae which have the same location. Otherwise, a transmission delay resulting from a location difference of the antenna may lead to asynchronous arrival at a receiving end even if the synchronous signal is sent at the same time. At this flow, the synchronous signal includes the PSS and the SSS. To perform the synchronous transmission of the synchronous signal means that an error between a sending time-sequence that each CC transmits the PSS and the SSS is within a determined range. That is, the PSS and the SSS can have the same, or alternatively approximately the same, sending time-sequence. FIGS. 2A and 2B provide schematic diagrams illustrating the synchronous transmission of the synchronous signal of each CC in an FDD system and a TDD system, respectively.

The synchronous transmission of the PSS and the SSS can ensure the synchronous transmission of a CRS on each CC.

In the present invention, the at least two CCs for performing the synchronous transmission on distinct antenna locations can have the same combination, or alternatively distinct combinations.

In particular embodiments, the base station can send the same PCI on the above at least two CCs involved at this flow. That is, the PSS and the SSS transmitted on those CCs have the same sequence, and the CRS also has the same scrambling code sequence.

Flow 102: Information regarding one or more CCs among the at least two CCs that can be carrier aggregated with a carrier of a serving cell is sent to a user equipment within this serving cell through higher-level signaling.

Specifically, the CC that has corresponding antenna which has the same location and which is capable of performing the CA with the carrier of the serving cell actually has the information regarding the CC for performing the inter-carrier synchronous transmission of the synchronous signal with the carrier of the inter-carrier.

The CC of the serving cell involved at this flow can be a Primary Component Carrier (PCC) that the base station configures for the user equipment.

The higher-level signaling sent by the base station of the serving cell can be a system broadcast within the cell, or alternatively a dedicated RRC message with respect to the user equipment.

Flow 103: Joint mobility measurement information is sent to the user equipment of this serving cell, so that the user equipment determines the CC for performing joint mobility measurement according to the above information regarding the CC and the joint mobility measurement information and performs the joint mobility measurement on the determined CC.

The joint mobility measurement information involved at this flow can be transmitted through the system broadcast of the cell or the dedicated RRC message with respect to the user equipment. Specifically, if the transmission is performed in the system broadcast of the cell, the user equipment can perform the joint mobility measurement in an Idle Mode. If the transmission is performed in the RRC message, the user equipment can perform the joint mobility measurement in a Connected Mode.

The joint mobility measurement by the user equipment involves performing joint cell identification detection, or alternatively joint RSRP measurement, on multiple CCs.

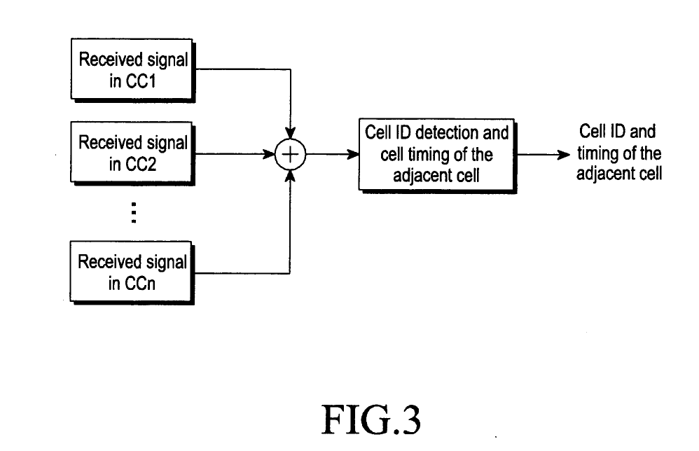

Specifically, the joint cell identification detection can involve combining joint cell identification. That is, the user equipment combines and adds up the signal received on multiple CCs, and then performs cell timing detection and cell ID detection on the combined signal. The combining joint cell identification method is as shown in FIG. 3.

Furthermore, selective joint cell identification is also possible. That is, the user equipment performs the cell timing detection and the cell ID detection on the signal received on each CC until the cell identification is completed on a certain CC. In the selective joint cell identification method, if the corresponding antenna has the same location and distinct PCIs are sent on the CC for performing the CA with the carrier of the serving cell, the user equipment will take cell timing of this CC as the cell timing of another CC after completing the cell identification of one of the CCs, and then perform the cell ID detection of another carrier.

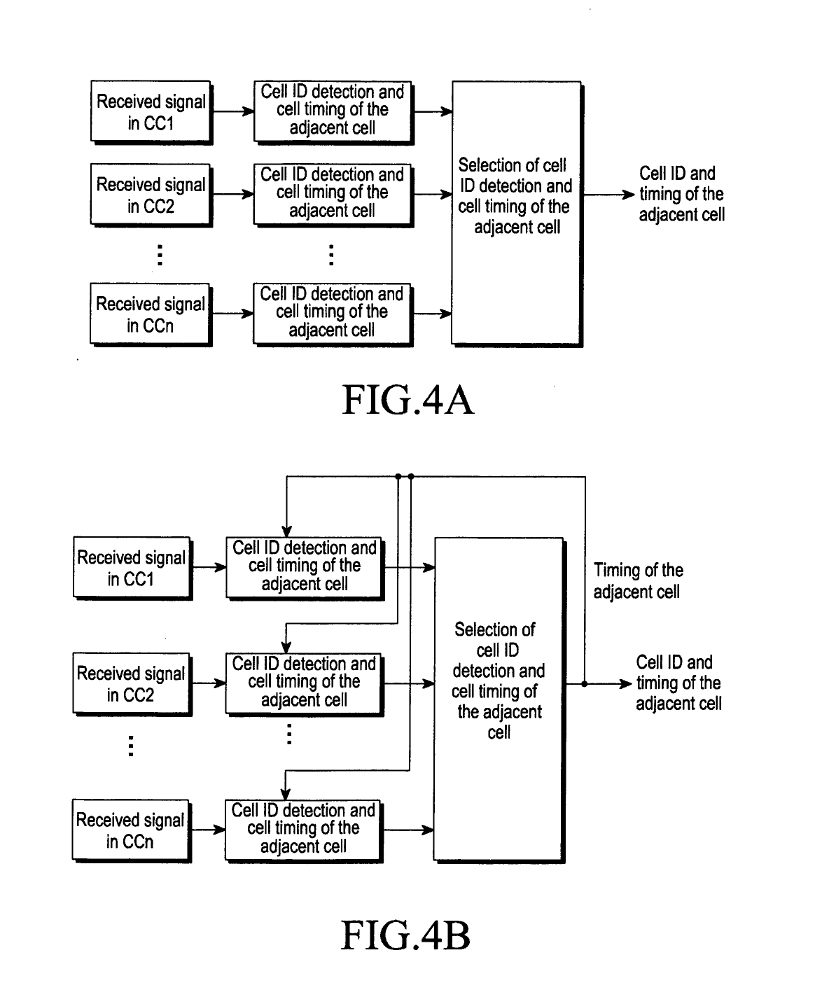

The selective joint cell identification method in which the same PCI is transmitted on each CC is shown in FIG. 4A, and the selective joint cell identification method in which distinct PCIs are transmitted on each CC is shown in FIG. 4B.

The above joint RSRP measurement performed on multiple CCs can involve averaging an RSRP value obtained by performing the measurement on multiple CCs, so as to obtain the average RSRP value on multiple CCs.

Specifically, at flow 103, the joint mobility measurement information sent to the user equipment of this serving cell can be one or any combination of information as follows.

First: information for indicating whether the user equipment can perform the joint mobility measurement. Accordingly, if it is indicated that the user equipment can perform the joint mobility measurement, the user equipment performs the joint mobility measurement on the CC corresponding to the information sent at flow 102.

Second: information for indicating a manner by which the user equipment performs the joint mobility measurement. Specifically, the manner of the joint mobility measurement can be a combining joint cell identification manner, a selective joint cell identification manner or a joint RSRP measurement manner.

Third: indication of whether the PSS and the SSS correspond to the same PCI on the CC for performing the joint mobility measurement.

Fourth: information for indicating a CA deployment scenario used by the CC for performing the joint mobility measurement. The user equipment can determine whether the joint mobility measurement is to be performed and a joint mobility measurement method to be used (i.e., the combining joint cell identification method, the selective joint cell identification method or the joint RSRP measurement) according to the information regarding the deployment scenario.

Fifth: information for indicating whether the CC for performing the joint mobility measurement is a continuous CC or a non-continuous CC. The user equipment can perform the joint mobility measurement on the continuous CC.

Sixth: information for indicating whether the CC for performing the joint mobility measurement is on the same frequency band. The user equipment can perform the joint mobility measurement on the CC of the same frequency band.

Seventh: information for indicating the CC required for the user equipment to perform the joint mobility measurement. Such information regarding the CC can be part or all of the information regarding the CC sent at flow 102, and may also be more adequate than the information regarding the CC sent at flow 102. After obtaining the information regarding the CC required for the joint mobility measurement, the user equipment determines the CC for which the joint mobility measurement can be performed, which typically is part or all of the CC corresponding to the information sent at flow 102, and then performs the joint mobility measurement on those CCs. An indication manner in this case can specifically include the following. It is indicated that the CC for the user equipment to perform the joint mobility measurement is the same as the CC of the serving cell. Thus, the user equipment performs the joint mobility measurement on the CC of the serving cell. Alternatively, it is indicated that the CC used for the joint mobility measurement regarding the serving cell is a subset of the CC used for the joint mobility measurement regarding the adjacent cell. Thus, the user equipment performs the joint mobility measurement on the CC used for the joint mobility measurement regarding the serving cell. Alternatively, the CC in the serving cell used for the joint mobility measurement of the adjacent cell is indicated. Thus, the user equipment performs the joint mobility measurement on the indicated CC.

Several examples of combining the above joint mobility measurement information are listed in the following. For example, the second and the seventh manners are combined. That is, the information for indicating the manner that the user equipment performs the joint mobility measurement and the information for indicating the CC required for performing the joint mobility measurement are merged. Thus, after receiving the above information, the user equipment determines the CC that the joint mobility measurement is located using the information regarding the CC required for performing the joint mobility measurement, and performs the joint mobility measurement in the indicated manner of the joint mobility measurement on the determined CC. Another combination of the information can be the combination of the fourth and the seventh. That is, the information regarding the CC required for performing the joint mobility measurement and the information for indicating the CA deployment scenario of the CC are merged. After receiving such information combination, the user equipment can determine the manner of the joint mobility measurement that can be used according to the indicated CA scenario, and then performs the joint mobility measurement on the CC on which the joint CC mobility measurement can be performed.

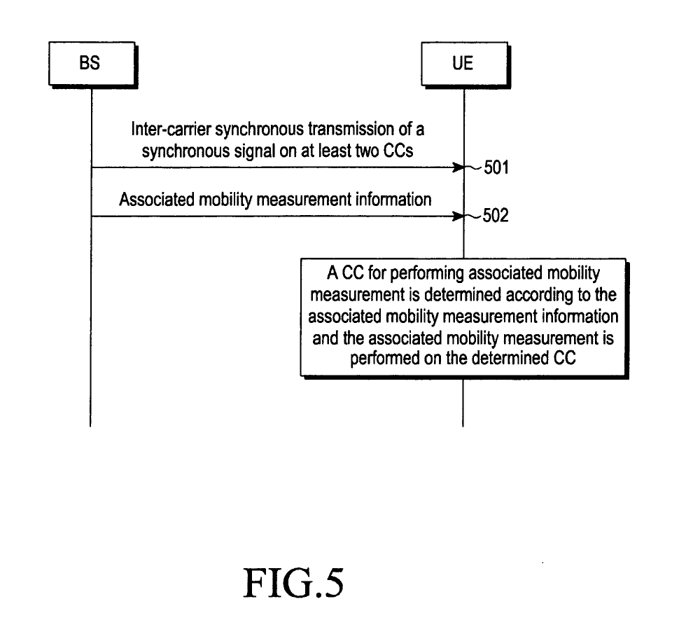

Furthermore, the present invention provides another implementation method in addition to the above method, which can be as shown in FIG. 5.

Flow 501: Inter-carrier synchronous transmission of a synchronous signal is performed on at least two CCs.

At this flow, the base station can perform the inter-carrier synchronous transmission of the synchronous signal on the CCs that have corresponding antennae which have the same location. Otherwise, a transmission delay resulting from a location difference of the antenna may lead to asynchronous arrival at a receiving end even if the synchronous signal is sent at the same time. At this flow, the synchronous signal includes the PSS and the SSS. To perform the synchronous transmission of the synchronous signal means that an error between a sending time-sequence that each CC transmits the PSS and the SSS is within a determined range. That is, the PSS and the SSS can have the same, or alternatively approximately the same, sending time-sequence. FIGS. 2A and 2B provide schematic diagrams illustrating the synchronous transmission of the synchronous signal of each CC in an FDD system and a TDD system, respectively.

The synchronous transmission of the PSS and the SSS can ensure the synchronous transmission of a CRS on each CC.

In particular embodiments, the base station can send the same PCI on the above at least two CCs involved at this flow. That is, the PSS and the SSS transmitted on those CCs have the same sequence, and the CRS also has the same scrambling code sequence.

Flow 502: Joint mobility measurement information is sent to the user equipment of this serving cell, so that the user equipment determines the CC for performing joint mobility measurement according to the joint mobility measurement information and performs the joint mobility measurement on the determined CC.

The joint mobility measurement information involved in at this flow can be transmitted through the system broadcast of the cell or the dedicated RRC message with respect to the user equipment. Specifically, if the transmission is performed in the system broadcast of the cell, the user equipment can perform the joint mobility measurement in an Idle Mode. If the transmission is performed in the dedicated RRC message with respect to the user equipment, the user equipment can perform the joint mobility measurement in a Connected Mode.

The joint mobility measurement by the user equipment involves performing joint cell identification detection, or alternatively joint RSRP measurement, on multiple CCs.

Specifically, the joint cell identification detection can involve combining joint cell identification. That is, the user equipment combines and adds up the signal received on multiple CCs, and then performs cell timing detection and cell ID detection on the combined signal. The combining joint cell identification method is as shown in FIG. 3.

Furthermore, selective joint cell identification is also possible. That is, the user equipment performs the cell timing detection and the cell ID detection on the signal received on each CC until the cell identification is completed on a certain CC. In the selective joint cell identification method, if the corresponding antenna has the same location and distinct PCIs are sent on the CC for performing the CA with the carrier of the serving cell, the user equipment will take cell timing of the CC as the cell timing of another CC after completing the cell identification of one of the CCs, and then perform the cell ID detection of another carrier.

The selective joint cell identification method in which the same PCI is transmitted on each CC is shown in FIG. 4A, and the selective joint cell identification method in which distinct PCIs are transmitted on each CC is shown in FIG. 4B.

The above joint RSRP measurement performed on multiple CCs can involve averaging an RSRP value obtained by performing the measurement on multiple CCs, so as to obtain the average RSRP value on multiple CCs.

Specifically, at flow 202, the joint mobility measurement information sent to the user equipment of this serving cell includes the seventh mobility measurement information in the first method, i.e. the information for indicating the CC required for the user equipment to perform the joint mobility measurement. The carrier information can be the carrier information for indicating the CC for performing the joint mobility measurement. Thus, the user equipment performs the joint mobility measurement on the indicated CC.

Furthermore, one or any combination of the above second to six mobility measurement information can be included in addition to the seventh mobility measurement information.

Second: information for indicating a manner by which the user equipment performs the joint mobility measurement. Specifically, the manner of the joint mobility measurement can be a combining joint cell identification manner, a selective joint cell identification manner or an joint RSRP measurement manner.

Third: indication of whether the PSS and the SSS correspond to the same PCI on the CC for performing the joint mobility measurement.

Fourth: information for indicating a CA deployment scenario used by the CC for performing the joint mobility measurement. The user equipment can determine whether the joint mobility measurement is to be performed and a joint mobility measurement method to be used (i.e., the combining joint cell identification method, the selective joint cell identification method or the joint RSRP measurement) according to the information regarding the deployment scenario.

Fifth: information for indicating whether the CC for performing the joint mobility measurement is a continuous CC or a non-continuous CC. The user equipment can perform the joint mobility measurement on the continuous CC.

Sixth: information for indicating whether the CC for performing the joint mobility measurement is on the same frequency band. The user equipment can perform the joint mobility measurement on the CC of the same frequency band.

Three embodiments are listed in the following to describe methods provided by the present invention.

### Embodiment 1

The CA uses the deployment scenario 1. That is, there are other M−1 CCs that have the same coverage range in addition to the CC k, and the M CCs correspond to the antennae having the same location and using the same PCI. Certain user equipment is located within the coverage range. Specifically, the CC k is configured as the PCC of the user equipment. That is, the cell determined from the PCC and the PCI is the serving cell of the user equipment.

According to a method of the present invention, the following is considered.

The base station to which the M CCs belongs sends the PSS and the SSS in a synchronous manner on the M CCs, and the PSS and the SSS sent on the M CCs have the same sequence.

The base station for the serving cell of the user equipment sends the information regarding the other M−1 CCs, i.e. the information regarding the CC that is capable of performing the CA with the PCC, to the UE. Specifically, the base station can select N CCs from the M−1 CCs according to channel conditions on each CC or service requirements of a user to perform the CA with the PCC, so as to transmit data to the user equipment. Specifically, 0≦N≦M−1.

The base station for the serving cell that the user equipment is located sends the joint mobility measurement information to the user equipment through the higher-level signaling. The user equipment can determine the CC for performing the joint mobility measurement using the joint mobility measurement information and the information regarding the CC that is capable of performing the CA with the PCC, and perform the joint mobility measurement on the determined CC.

The above information regarding the CC can be sent through the system broadcast of the cell or the dedicated RRC message with respect to the user equipment, and the joint mobility measurement information can be sent through the system broadcast of the cell or the dedicated RRC message with respect to the user equipment.

In an embodiment, the joint mobility measurement performed by the user equipment can be the combining joint cell identification, the selective joint cell identification or the joint RSRP measurement.

The joint mobility measurement information involved in this embodiment can be any one or any combination of the above seven kinds of information. Specific contents are as follows.

The first information can be used. It is directly indicated that the user equipment can perform the joint mobility measurement. After receiving this information, the user equipment directly performs the joint mobility measurement on the CC corresponding to the information sent at flow 102.

The second information is also possible. That is, it is indicated that the user equipment uses the combining joint cell identification manner.

The third information is also possible. That is, it is indicated whether the PSS and the SSS on the CC corresponding to the information sent at flow 102 correspond to the same PCI.

The fourth information is also possible. After receiving this information, the user equipment determines that the current CA deployment scenario is the deployment scenario 1, and determines that the manner of the joint mobility measurement that can be performed by the user equipment is the combining joint cell identification.

The seventh information can be used. For example, it is indicated which CCs of the M carriers can be used for the joint mobility measurement of the adjacent cell. Specifically, the indication can be performed using bit mapping of M bits. Alternatively, it is indicated that the CC for performing the joint mobility measurement regarding the adjacent cell is the same as the CC for performing the joint mobility measurement regarding the serving cell. Specifically, the indication can be performed using 1 bit. Alternatively, it is indicated that the CC for performing the joint mobility measurement regarding the serving cell is a subset of the CC for performing the joint mobility measurement regarding the adjacent cell. Specifically, the indication can be performed using 1 bit.

The fifth or the six information can also be used. After receiving this information, the user equipment can then determine whether the joint RSRP measurement on multiple carriers can be performed.

### Embodiment 2

The CA uses the deployment scenario 2. That is, there are other M−1 CCs in addition to the CC k. The M CCs correspond to the antennae having the same location and the same direction, and use the same PCI. However, the cell covered by the M CCs has distinct coverage ranges. Certain user equipment is located within the coverage range of the cell of the CC k. Specifically, the CC k is configured as the PCC of the user equipment. That is, the cell determined from the PCC and the PCI is the serving cell of the user equipment.

Several examples of combining the above joint mobility measurement information are listed in the following. For example, the second and the seventh manners are combined. That is, the information for indicating the manner that the user equipment performs the joint mobility measurement and the information for indicating the CC required for performing the joint mobility measurement are merged. Thus, after receiving the above information, the user equipment determines the CC that the joint mobility measurement is located using the information regarding the CC required for performing the joint mobility measurement, and performs the joint mobility measurement in the indicated manner of the joint mobility measurement on the determined CC. Another combination of the information can be the combination of the fourth and the seventh. That is, the information regarding the CC required for performing the joint mobility measurement and the information for indicating the CA deployment scenario of the CC are merged. After receiving such information combination, the user equipment can determine the manner of the joint mobility measurement that can be used according to the indicated CA scenario, and then perform the joint mobility measurement on the CC on which the joint CC mobility measurement can be performed.

According to a method of the present invention, the following is considered.

The base station to which the M CCs belongs sends the PSS and the SSS in a synchronous manner on the M CCs, and the PSS and the SSS sent on the M CCs have the same sequence.

The base station for the serving cell of the user equipment sends the information regarding the other M−1 CCs, i.e. the information regarding the CC that is capable of performing the CA with the PCC, to the UE. Specifically, the base station can select N CCs from the M−1 CCs according to channel conditions on each CC or service requirements of a user to perform the CA with the PCC, so as to transmit data to the user equipment. Specifically, 0≦N≦M−1.

The base station for the serving cell that the user equipment is located sends the joint mobility measurement information to the user equipment through the higher-level signaling. The user equipment can determine the CC for performing the joint mobility measurement using the joint mobility measurement information and the information regarding the CC that is capable of performing the CA with the PCC, and perform the joint mobility measurement on the determined CC.

The above information regarding the CC can be sent through the system broadcast of the cell or the RRC message, and the joint mobility measurement information can be sent through the system broadcast of the cell or the RRC message.

In an embodiment, the joint mobility measurement performed by the user equipment can be the selective joint cell identification.

The joint mobility measurement information involved in this embodiment can be any one or any combination of the above seven kinds of information. Specific contents are as follows.

The seventh information can be used. That is, the information regarding the CC required for the user equipment to perform the joint mobility measurement is indicated, and the user equipment can then perform the joint mobility measurement on those CCs after receiving the information regarding the carrier. For example, it can be indicated which CCs in the serving cell can be used for the joint mobility measurement of multiple CCs of the adjacent cell. Specifically, this means which CCs of the M carriers can be used for the joint mobility measurement of the adjacent cell. The indication can be performed using bit mapping of M bits. Alternatively, it can be indicated that the CC for performing the joint mobility measurement regarding the adjacent cell is the same as the CC for performing the joint mobility measurement regarding the serving cell. Specifically, the indication can be performed using 1 bit. Alternatively, it can be indicated that the CC for performing the joint mobility measurement regarding the serving cell is a subset of the CC for performing the joint mobility measurement regarding the adjacent cell. Specifically, the indication can be performed using 1 bit.

The third information can also be used. That is, it is indicated whether the PSS and the SSS on the CC corresponding to the information sent at flow 102 correspond to the same PCI.

The fourth information is also possible. That is, the information regarding the current CA deployment scenario is indicated. After receiving this information, the user equipment determines that the current CA deployment scenario is the deployment scenario 2, and determines that the manner of the joint mobility measurement that can be performed by the user equipment is the selective joint cell identification.

The second information is also possible. That is, it is indicated that the user equipment uses the selective joint cell identification.

The first information can be used. That is, it is directly indicated whether the user equipment can perform the joint mobility measurement. Accordingly, upon receiving the indication that the joint mobility measurement can be performed, the user equipment performs the joint mobility measurement on the CC corresponding to the information sent at flow 102.

The fourth or the fifth manner can also be used. Detailed description thereof is omitted herein.

### Embodiment 3

The CA uses the deployment scenario 1 or 2. There are other M−1 CCs in addition to the CC k. They may have the same coverage range or distinct coverage ranges. The M CCs correspond to the antennae having the same location and the same direction, but use distinct PCIs. Certain user equipment is located within the coverage range. Specifically, the CC k is configured as the PCC of the user equipment.

According to a method of the present invention, the following is considered.

The base station to which the M CCs belongs sends the PSS and the SSS in a synchronous manner on the M CCs, and the PSS and the SSS sent on the M CCs have the same sequence.

The base station for the serving cell of the user equipment sends the information regarding the other M−1 CCs, i.e. the information regarding the CC that is capable of performing the CA with the PCC, to the UE. Specifically, the base station can select N CCs from the M−1 CCs according to channel conditions on each CC or service requirements of a user to perform the CA with the PCC, so as to transmit data to the user equipment. Specifically, 0≦N≦M−1.

The base station for the serving cell that the user equipment is located sends the joint mobility measurement information to the user equipment through the higher-level signaling. The user equipment can determine the CC for performing the joint mobility measurement using the joint mobility measurement information and the information regarding the CC that is capable of performing the CA with the PCC, and perform the joint mobility measurement on the determined CC.

The above information regarding the CC can be sent through the system broadcast of the cell or the RRC message, and the joint mobility measurement information can be sent through the system broadcast of the cell or the RRC message.

In an embodiment, the joint mobility measurement performed by the user equipment can be the selective joint cell identification.

The joint mobility measurement information involved in this embodiment can be any one or any combination of the following several kinds.

The seventh information can be used. That is, the information regarding the CC required for the user equipment to perform the joint mobility measurement is indicated. The user equipment can perform the joint mobility measurement on the determined CCs after receiving the indication information. For example, it is indicated which CCs in the serving cell can be used for the joint mobility measurement of the CC of the adjacent cell. The indication can be performed using bit mapping of M bits. Alternatively, it is indicated that the CC for performing the joint mobility measurement regarding the adjacent cell is the same as the CC for performing the joint mobility measurement regarding the serving cell. The indication can be performed using 1 bit. Alternatively, it can be indicated that the CC for performing the joint mobility measurement regarding the serving cell is a subset of the CC for performing the joint mobility measurement regarding the adjacent cell. The indication can be performed using 1 bit.

The third information can also be used. That is, it is indicated whether the PSS and the SSS on the CC corresponding to the information sent at flow 102 correspond to the same PCI. When the user equipment receives the information for indicating that the PSS and the SSS transmitted on multiple CCs correspond to distinct PCIs, the user equipment may then use the selective joint cell identification method. That is, the user equipment performs the cell timing detection and the cell ID detection on the signal received on each CC until the cell identification is completed on a certain CC, then takes cell timing of the CC on which the cell identification is completed as the cell timing of another CC, and then performs the cell ID detection of another carrier.

As can be seen from the above technical solutions, in the method provided by the present invention, by performing the synchronous transmission of the synchronous signal on at least two CCs that have corresponding antennae which have the same location and sending the information regarding the CC for performing the CA with the carrier of the serving cell and the joint mobility measurement information to the user equipment, the user equipment can determine the CC for performing the joint mobility measurement according to this information and can perform the joint mobility measurement on the determined CC without measuring the different-frequency carriers one by one, which improves the performance of the measurement, increases the speed of the mobility measurement and reduces the power consumption of the user equipment.

Although the present disclosure has been described with an exemplary embodiment, various changes and modifications may be suggested to one skilled in the art. It is intended that the present disclosure encompass such changes and modifications as fall within the scope of the appended claims.

What is claimed is:

1. A mobility cell measurement method for a mobile communications system, the method comprising:
performing inter-carrier synchronous transmission of a synchronous signal on at least two Component Carriers (CCs);
sending information regarding one or more CCs among the at least two CCs that can be aggregated with a carrier of a serving cell to an user equipment through higher-level signaling; and
sending joint mobility measurement information to the user equipment of the serving cell,
wherein the user equipment determines a CC for performing joint mobility measurement according to the information regarding the one or more CCs and the joint mobility measurement information and performs the joint mobility measurement on the determined CC.

2. The method according to claim 1, wherein the carrier of the serving cell is a Primary Component Carrier (PCC) configured for the user equipment.

3. The method according to claim 1, wherein sending joint mobility measurement information comprises: combining joint cell identification, selective joint cell identification or joint Reference Signal Received Power (RSRP) measurement.

4. The method according to claim 1, wherein the joint mobility measurement information comprises at least one of:
information for indicating whether the user equipment can perform the joint mobility measurement;
information for indicating a manner that the user equipment performs the joint mobility measurement, wherein the manner of the joint mobility measurement includes a combining joint cell identification manner, a selective joint cell identification manner or an joint RSRP measurement manner;
indication of whether the synchronous signal corresponds to the same Physical Cell ID PCI on the CC for performing the joint mobility measurement;
information for indicating a CA deployment scenario used by the CC for performing the joint mobility measurement;
information for indicating whether the CC for performing the joint mobility measurement is a continuous CC or a non-continuous CC;
information for indicating whether the CC for performing the joint mobility measurement is on the same frequency band; and
information for indicating the CC required for the user equipment to perform the joint mobility measurement.

5. The method according to claim 4, wherein the information for indicating the CC required for the user equipment to perform the joint mobility measurement comprises one of:
an indication that the CC for performing the joint mobility measurement is the same as the CC of the serving cell,
an indication that the CC used for the joint mobility measurement regarding the serving cell is a subset of the CC used for the joint mobility measurement regarding the adjacent cell, and
an indication that the CC among the CC of the serving cell that is used for the joint mobility measurement of the adjacent cell.

6. A mobility cell measurement method for a mobile communications system, the method comprising:
performing inter-carrier synchronous transmission of a synchronous signal on at least two Component Carriers (CCs); and
sending joint mobility measurement information to a user equipment of a serving cell,
wherein the user equipment determines a CC for performing joint mobility measurement according to the joint mobility measurement information and performs the joint mobility measurement on the determined CC.

7. The method according to claim 6, wherein sending joint mobility measurement information to a user equipment of a serving cell comprises: combining joint cell identification, selective joint cell identification or joint Reference Signal Received Power (RSRP) measurement.

8. The method according to claim 6, wherein the joint mobility measurement information comprises information indicating the CC required for the user equipment to perform the joint mobility measurement, or comprises at least one of the following in addition to the information for indicating the CC required for the user equipment to perform the joint mobility measurement:
information for indicating a manner that the user equipment performs the joint mobility measurement, wherein the manner of the joint mobility measurement includes a combining joint cell identification manner, a selective joint cell identification manner or an joint RSRP measurement manner;
indication of whether the synchronous signal corresponds to the same Physical Cell ID PCI on the CC for performing the joint mobility measurement;
information for indicating a CA deployment scenario used by the CC for performing the joint mobility measurement;
information for indicating whether the CC for performing the joint mobility measurement is a continuous CC or a non-continuous CC; and
information for indicating whether the CC for performing the joint mobility measurement is on the same frequency band.

9. A mobility cell measurement apparatus for a mobile communications system, the apparatus comprising:
a controller configured to perform inter-carrier synchronous transmission of a synchronous signal on at least two Component Carriers (CCs); and
a transmitter configured to send information regarding one or more CCs among the at least two CCs that can be aggregated with a carrier of a serving cell to a user equipment through higher-level signaling, and send joint mobility measurement information to the user equipment of the serving cell,
wherein the user equipment determines a CC for performing joint mobility measurement according to the information regarding the one or more CCs and the joint mobility measurement information and performs the joint mobility measurement on the determined CC.

10. The apparatus according to claim 9, wherein the carrier of the serving cell is a Primary Component Carrier (PCC) configured for the user equipment.

11. The apparatus according to claim 9, wherein in sending joint mobility measurement information, the transmitter is configured to combine joint cell identification, selective joint cell identification or joint Reference Signal Received Power (RSRP) measurement.

12. The apparatus according to claim 9, wherein the joint mobility measurement information comprises at least one of:
information for indicating whether the user equipment can perform the joint mobility measurement;
information for indicating a manner that the user equipment performs the joint mobility measurement, wherein the manner of the joint mobility measurement includes a combining joint cell identification manner, a selective joint cell identification manner or an joint RSRP measurement manner;
indication of whether the synchronous signal corresponds to the same Physical Cell ID PCI on the CC for performing the joint mobility measurement;
information for indicating a CA deployment scenario used by the CC for performing the joint mobility measurement;
information for indicating whether the CC for performing the joint mobility measurement is a continuous CC or a non-continuous CC;
information for indicating whether the CC for performing the joint mobility measurement is on the same frequency band; and
information for indicating the CC required for the user equipment to perform the joint mobility measurement.

13. The apparatus according to claim 12, wherein the information for indicating the CC required for the user equipment to perform the joint mobility measurement comprises one of:
an indication that the CC for performing the joint mobility measurement is the same as the CC of the serving cell,
an indication that the CC used for the joint mobility measurement regarding the serving cell is a subset of the CC used for the joint mobility measurement regarding the adjacent cell, and
an indication that the CC among the CC of the serving cell that is used for the joint mobility measurement of the adjacent cell.

14. The apparatus according to claim 9, wherein the transmitter is configured to send the joint mobility measurement information through a system broadcast of the serving cell or a dedicated Radio Resource Control (RRC) message with respect to the user equipment.

15. A mobility cell measurement apparatus for a mobile communications system, the apparatus comprising:
a controller configured to perform inter-carrier synchronous transmission of a synchronous signal on at least two Component Carriers CCs; and
a transmitter configured to send joint mobility measurement information to the user equipment of the serving cell,
wherein the user equipment determines a CC for performing joint mobility measurement according to the joint mobility measurement information and performs the joint mobility measurement on the determined CC.

16. The apparatus according to claim 15, wherein in sending joint mobility measurement information, the transmitter is configured to combine joint cell identification, selective joint cell identification or joint Reference Signal Received Power (RSRP) measurement.

17. The apparatus according to claim 15, wherein the joint mobility measurement information comprises information indicating the CC required for the user equipment to perform the joint mobility measurement, or comprises at least one of the following in addition to the information for indicating the CC required for the user equipment to perform the joint mobility measurement:
information for indicating a manner that the user equipment performs the joint mobility measurement, wherein the manner of the joint mobility measurement includes a combining joint cell identification manner, a selective joint cell identification manner or an joint RSRP measurement manner;
indication of whether the synchronous signal corresponds to the same Physical Cell ID PCI on the CC for performing the joint mobility measurement;
information for indicating a CA deployment scenario used by the CC for performing the joint mobility measurement;
information for indicating whether the CC for performing the joint mobility measurement is a continuous CC or a non-continuous CC; and
information for indicating whether the CC for performing the joint mobility measurement is on the same frequency band.

18. The apparatus according to claim 15, wherein the transmitter is configured to send the joint mobility measurement information through a system broadcast of the serving cell or a dedicated Radio Resource Control (RRC) message with respect to the user equipment.

19. The apparatus according to claim 18, wherein if the joint mobility measurement information transmission is performed through the system broadcast of the serving cell, the user equipment performs joint mobility measurement in an idle mode.

20. The apparatus according to claim 18, wherein if the joint mobility measurement information transmission is performed in the RRC message, the user equipment performs joint mobility measurement in a connected mode.
